(19) United States
(12) Patent Application Publication
(10) Pub. No.: US 2003/0084771 A1
(43) Pub. Date: May 8, 2003

(54) Portable power saw guide system

(76) Inventors: Victor J. Taormina, Arvada, CO (US); Harvey M. Wilford, Edgewater, CO (US)

Correspondence Address: Michael S. Neustel, Suite No. 4, 2534 South University Drive, Fargo, ND, 58103, US

(21) Appl. No.: 10/013,004

(22) Filed: Nov. 5, 2001

(51) Int. Cl. B27B 11/02

(52) U.S. Cl. 83/574; 83/581; 83/821

(57) ABSTRACT

A portable power saw guide system for properly aligning a power saw with respect to a board member at various angles thereby facilitating efficient and accurate cutting of the board member. The portable power saw guide system includes a main body having a first segment and a second segment, a receiver channel extending within the main body between the segments for receiving an elongate board member, a plurality of guide slots and blade slots extending traversely within the upper surface of the main body, and an alignment member attached to the lower surface of a support base upon a power saw, wherein the alignment member is slidably received by the guide slots. The first segment and the second segment of the main body have a height sufficient for the lower surface of the alignment member to pass over the upper surface of a board member within the receiver channel thereby allowing the cutting blade to sever the board member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to power saw guide devices and more specifically it relates to a portable power saw guide system for properly aligning a power saw with respect to a board member at various angles thereby facilitating efficient and accurate cutting of the board member.

2. Description of the Prior Art

Power saws have been in use for years. Typically, a power saw is comprised of a support base having a slot within, an electric motor attached to the support base, and a circular blade attached to the motor and extending downwardly partially through the slot within the support base for cutting a board member. There are various other types of power saws and power tools that may be utilized with the present invention. It is often times desirable to cut a board member at 90, 45 and 33.9 degrees for various applications.

The main problem with conventional power saws is that properly aligning the saw blade with respect to the board member at various common angles can be relatively difficult to accomplish in an efficient and accurate manner. A further problem is that properly cutting board members at precise angles so that they are able to properly abut one another is difficult to accomplish with conventional tools.

Examples of patented devices which are related to the present invention include U.S. Pat. No. 2,773,523 to Hopla; U.S. Pat. No. 4,909,111 to Noble; U.S. Pat. No. 4,920,845 to Blanchette; U.S. Pat. No. 4,916,994 to Hatala; U.S. Pat. No. 4,519,280 to Cook; U.S. Pat. No. 4,320,678 to Volk; and U.S. Pat. No. 4,050,340 to Flanders.

While these devices may be suitable for the particular purpose to which they address, they are not as suitable for properly aligning a power saw with respect to a board member at various angles thereby facilitating efficient and accurate cutting of the board member. Conventional tools and tool aides are not designed for facilitating accurate and efficient cutting of board members at various angles.

In these respects, the portable power saw guide system according to the present invention substantially departs from the conventional concepts and designs of the prior art, and in so doing provides an apparatus primarily developed for the purpose of properly aligning a power saw with respect to a board member at various angles thereby facilitating efficient and accurate cutting of the board member.

### SUMMARY OF THE INVENTION

In view of the foregoing disadvantages inherent in the known types of tools now present in the prior art, the present invention provides a new portable power saw guide system construction wherein the same can be utilized for properly aligning a power saw with respect to a board member at various angles thereby facilitating efficient and accurate cutting of the board member.

The general purpose of the present invention, which will be described subsequently in greater detail, is to provide a new portable power saw guide system that has many of the advantages of the tools mentioned heretofore and many novel features that result in a new portable power saw guide system which is not anticipated, rendered obvious, suggested, or even implied by any of the prior art tools, either alone or in any combination thereof.

To attain this, the present invention generally comprises a main body having a first segment and a second segment, a receiver channel extending within the main body between the segments for receiving an elongate board member, a plurality of guide slots and blade slots extending traversely within the upper surface of the main body, and an alignment member attached to the lower surface of a support base upon a power saw, wherein the alignment member is slidably received by the guide slots. The first segment and the second segment of the main body have a height sufficient for the lower surface of the alignment member to pass over the upper surface of a board member within the receiver channel thereby allowing the cutting blade to sever the board member.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a portable power saw guide system that will overcome the shortcomings of the prior art devices.

A second object is to provide a portable power saw guide system for properly aligning a power saw with respect to a board member at various angles thereby facilitating efficient and accurate cutting of the board member.

Another object is to provide a portable power saw guide system that may be utilized in various locations.

An additional object is to provide a portable power saw guide system that is portable to be utilized upon a remote work site.

A further object is to provide a portable power saw guide system that allows the user to cut a board member at various angles including but not limited to 90 degrees, 45 degrees and 33.9 degrees.

Another object is to provide a portable power saw guide system that is capable of receiving various sizes, widths, lengths, thickness and shapes of board members.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention with an elongate board member positioned within.

FIG. 2 is a top view of the present invention.

FIG. 3 is an end view of the present invention.

FIG. 4 is a side view of the present invention.

FIG. 5 is a lower perspective view of the alignment member attached to the support base of a power saw.

FIG. 6 is a side view of a power saw cutting through a board member.

FIG. 7 is a side view of a power saw cutting through a board member with the power saw and the alignment member passing through the main body of the present invention.

### DESCRIPTION OF THE PREFERRED EMBODIMENT

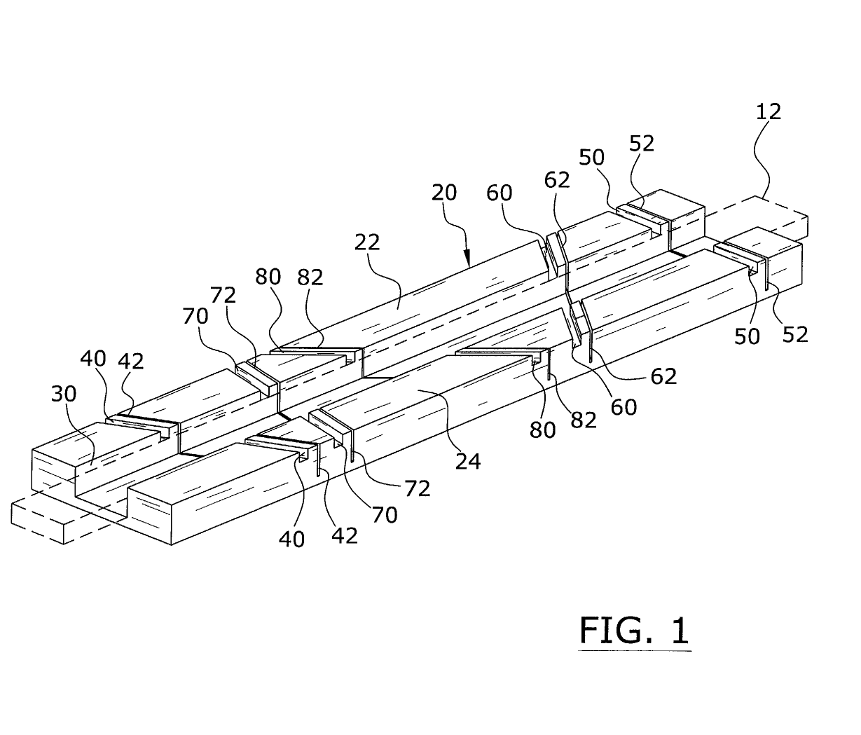

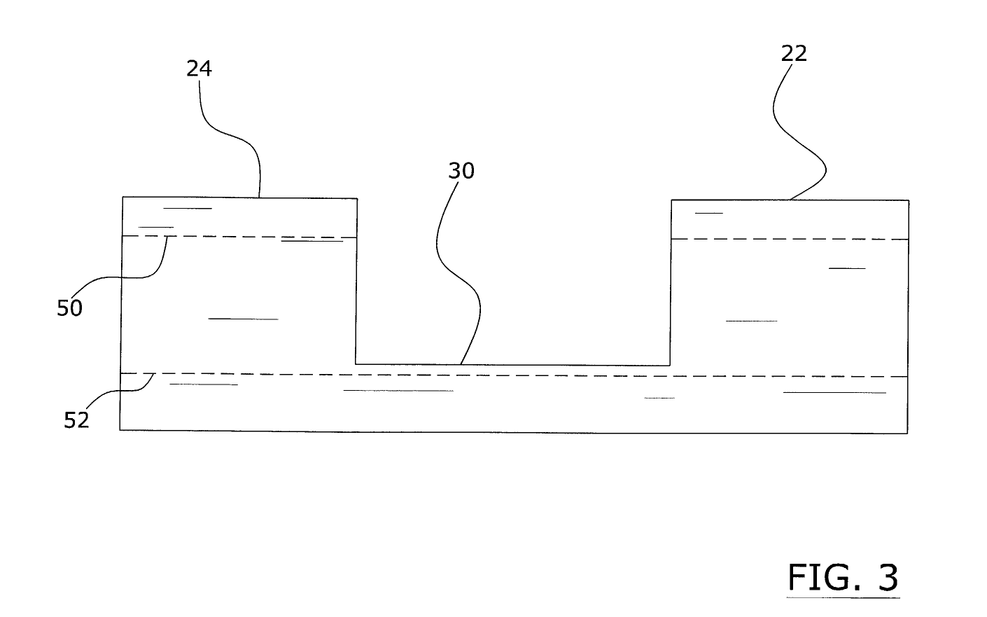

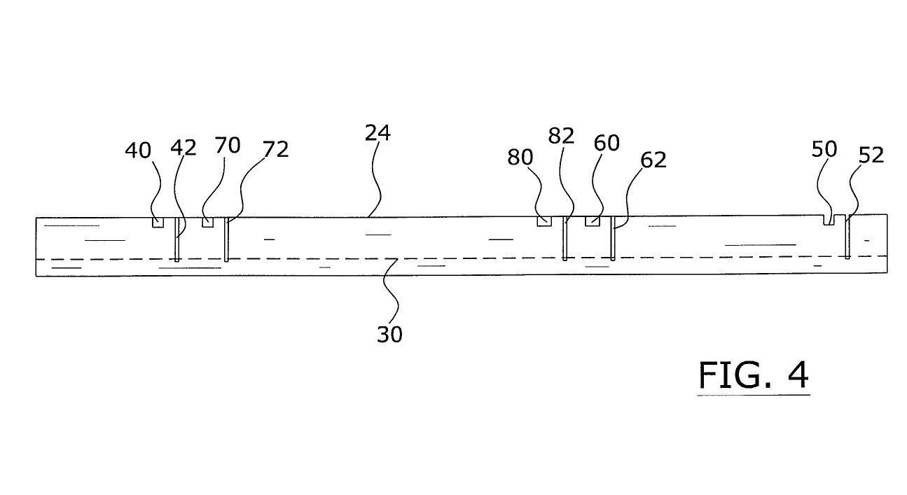

Turning now descriptively to the drawings, in which similar reference characters denote similar elements throughout the several views, FIGS. 1 through 7 illustrate a portable power saw guide system 10, which comprises a main body 20 having a first segment 22 and a second segment 24, a receiver channel 30 extending within the main body 20 between the segments for receiving an elongate board member 12, a plurality of guide slots and blade slots extending traversely within the upper surface of the main body 20, and an alignment member 90 attached to the lower surface of a support base 16 upon a power saw 14, wherein the alignment member 90 is slidably received by the guide slots. The first segment 22 and the second segment 24 of the main body 20 have a height sufficient for the lower surface of the alignment member 90 to pass over the upper surface of a board member 12 within the receiver channel 30 thereby allowing the cutting blade to sever the board member 12.

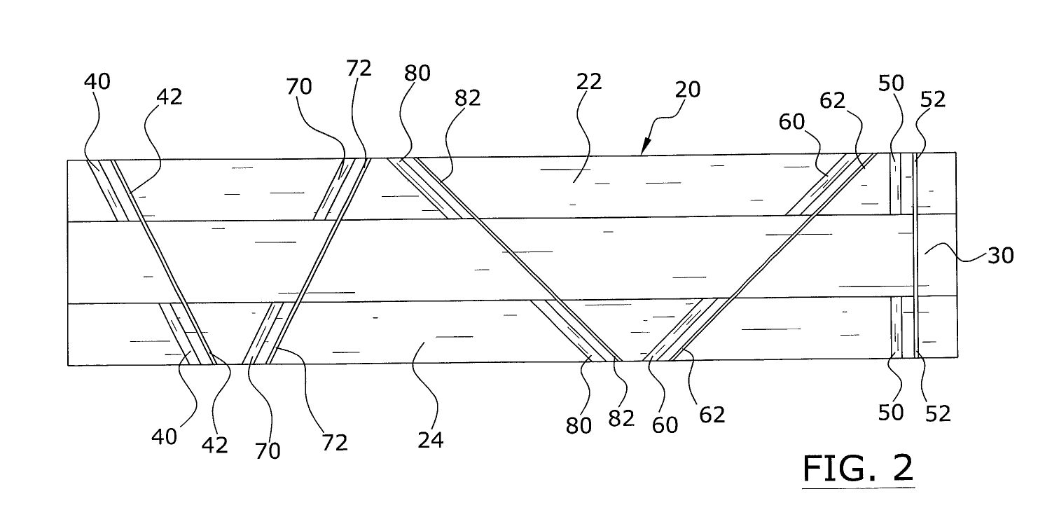

As shown in FIGS. 1 and 2 of the drawings, the main body 20 is preferably comprised of an elongate structure having an upper portion divided into a first segment 22 and a second segment 24, opposing end portions, opposing side portions, and a lower portion. The main body 20 may be comprised of various types of materials, shapes, structures and sizes. The main body 20 preferably has a length sufficient to provide for accurate alignment of a board member 12 within the receiver channel 30.

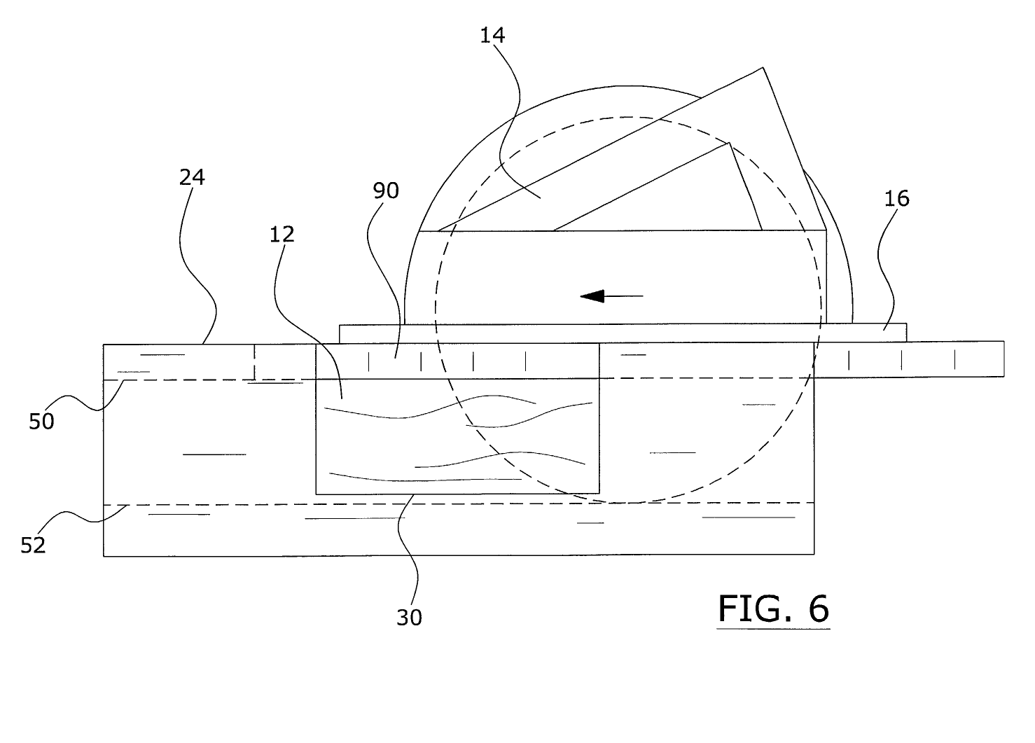

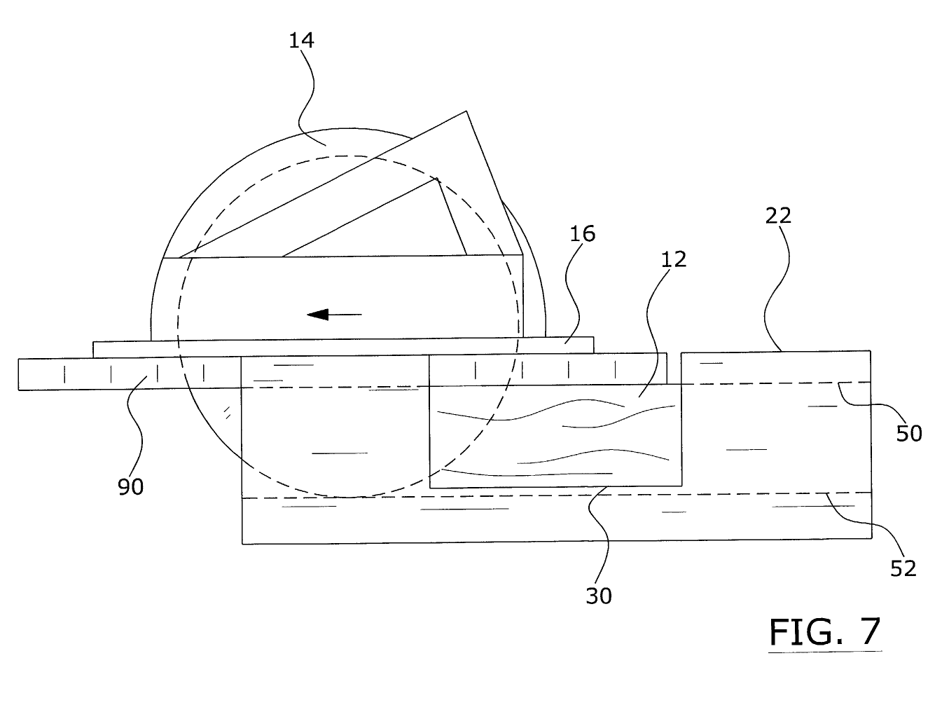

As shown in FIGS. 1 through 3 of the drawings, a receiver channel 30 having a depth A extends longitudinally within the upper portion of the main body 20 between the first segment 22 and the second segment 24. The receiver channel 30 is formed for receiving various sizes of a board member 12 such as but not limited to a 2×4, 2×6, or 2×12. The receiver channel 30 is of a sufficient depth that the upper surface of the board member 12 is below the lower surface of the support base 16 of the power saw 14 as best shown in FIGS. 6 and 7 of the drawings.

As shown in FIGS. 1 and 2 of the drawings, a plurality of guide slots 40, 50, 60, 70, 80 and a corresponding plurality of blade slots 42, 52, 62, 72, 82 extend parallel to one another within the upper portion of the main body 20 traversely across the receiver channel 30 from a first side to a second side. The plurality of guide slots 40, 50, 60, 70, 80 each have a depth B measured from the upper surface of the main body 20. The plurality of blade slots 42, 52, 62, 72, 82 each have a depth C measured from the upper surface of the main body 20. The blade slots 42, 52, 62, 72, 82 are formed for receiving the relatively narrow saw blade of a power saw 14. As shown in FIGS. 1, 2 and 4 of the drawings, the blade slots 42, 52, 62, 72, 82 are narrower than the guide slots 40, 50, 60, 70, 80. It can be appreciated that the blade slots 42, 52, 62, 72, 82 may be vertically orientated in a 90 degrees manner as shown in the drawings, or alternatively at an angle.

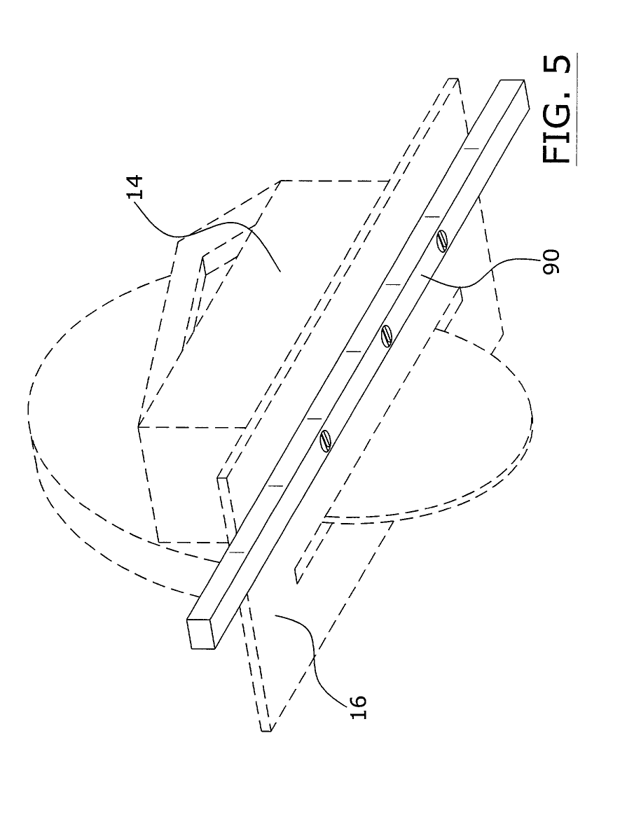

As shown in FIGS. 5 through 7 of the drawings, the alignment member 90 has an elongate structure attachable to a lower surface of a support base 16 for a power saw 14 parallel to a saw blade of the power saw 14. The alignment member 90 is slidably positionable within the plurality of guide slots 40, 50, 60, 70, 80 such that the saw blade freely passes within a corresponding blade slot 42, 52, 62, 72, 82. The alignment member 90 has a height B.

As shown in FIGS. 1, 2, 3 and 4 of the drawings, the depth C of the blade slots 42, 52, 62, 72, 82 is greater than the depth A of the receiver channel 30 thereby allowing the cutting blade of the power saw 14 to completely sever the board member 12 positioned within the receiver channel 30. As shown in FIGS. 1, 2, 3 and 4 of the drawings, the depth C of the blade slots 42, 52, 62, 72, 82 is preferably greater than the depth B of the guide slots 40, 50, 60, 70, 80. As best shown in FIGS. 6 and 7 of the drawings, the height B of the alignment member 90 is less than the difference between depth A and height A to allow the alignment member 90 to pass over the board member 12 during cutting thereof. The height B of the alignment member 90 is preferably approximately equal to the difference between depth A and height A.

As shown in FIGS. 1 and 2 of the drawings, the plurality of guide slots include a first guide slot 40 extending at an angle of approximately 56.1 degrees. As shown in FIGS. 1 and 2 of the drawings, the plurality of guide slots include a second guide slot 50 extending at an angle of approximately 90 degrees. As shown in FIGS. 1 and 2 of the drawings, the plurality of guide slots include a third guide slot 60 extending at an angle of approximately 135 degrees. As shown in FIGS. 1 and 2 of the drawings, the plurality of guide slots include a fourth guide slot 70 extending at an angle of approximately 123.9 degrees. As shown in FIGS. 1 and 2 of the drawings, the plurality of guide slots include a fifth guide slot 80 extending at an angle of approximately 45 degrees.

As shown in FIGS. 1 and 2 of the drawings, the first guide slot 40 and the fourth guide slot 70 are preferably positioned in opposition to one another. As shown in FIGS. 1 and 2 of the drawings, the third guide slot 60 and the fifth guide slot 80 are preferably positioned in opposition to one another. As shown in FIGS. 1 and 2 of the drawings, the second guide slot 50 is preferably positioned adjacent to an end of the main body 20 adjacent the third guide slot 60.

In use, the user first secures the alignment member 90 to the lower surface of the support base 16 of the power saw 14 in a manner parallel to the saw blade with fasteners or other conventional fastening means. The user then positions the board member 12 to be cut within the receiver channel 30 as shown in FIG. 1 of the drawings. The user then properly aligns the board member 12 with the proper blade slot 42, 52, 62, 72, 82 where the board member 12 is to be cut. The user then positions the alignment member 90 within the guide slot 40, 50, 60, 70, 80 adjacent to and corresponding to the selected blade slot 42, 52, 62, 72, 82. The user then operates the power saw 14 and manipulates the power saw 14 forwardly thereby cutting the board member 12 at the desired angle. The alignment member 90 slidably passes within the guide slot 40, 50, 60, 70, 80 and over the upper surface of the board member 12 as shown in FIGS. 6 and 7 of the drawings. The upper surface of the first segment 22 and the second segment 24 support the support base 16 of the power saw 14 thereby maintaining a desired position and elevation of the power saw 14.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A portable power saw guide system, comprising:
a main body having an elongate structure;
a receiver channel extending longitudinally within an upper portion of said main body from a first end to a second end of said main body, wherein said receiver channel has a depth A measured from an upper surface of said main body for receiving a board member having a height A;
a plurality of guide slots extending within said upper portion of said main body traversely across said receiver channel from a first side to a second side, wherein said plurality of guide slots each have a depth B measured from said upper surface of said main body;
a plurality of blade slots extending within said upper portion of said main body traversely across said receiver channel from said first side to said second side, wherein said plurality of blade slots each have a depth C measured from said upper surface of said main body; and
an alignment member having an elongate structure attachable to a lower surface of a support base for a power saw parallel to a saw blade of said power saw, wherein said alignment member is slidably positionable within said plurality of guide slots such that said saw blade freely passes within a corresponding blade slot and wherein said alignment member has a height B.

2. The portable power saw guide system of claim 1, wherein said depth C is greater than said depth A.

3. The portable power saw guide system of claim 2, wherein said depth C is greater than said depth B.

4. The portable power saw guide system of claim 1, wherein said height B of said alignment member is less than the difference between depth A and height A.

5. The portable power saw guide system of claim 1, wherein said height B of said alignment member is approximately equal to the difference between depth A and height A.

6. The portable power saw guide system of claim 1, wherein said plurality of guide slots include a first guide slot extending at an angle of approximately 56.1 degrees.

7. The portable power saw guide system of claim 6, wherein said plurality of guide slots include a second guide slot extending at an angle of approximately 90 degrees.

8. The portable power saw guide system of claim 7, wherein said plurality of guide slots include a third guide slot extending at an angle of approximately 135 degrees.

9. The portable power saw guide system of claim 8, wherein said plurality of guide slots include a fourth guide slot extending at an angle of approximately 123.9 degrees.

10. The portable power saw guide system of claim 9, wherein said plurality of guide slots include a fifth guide slot extending at an angle of approximately 45 degrees.

11. The portable power saw guide system of claim 10, wherein said first guide slot and said fourth guide slot are positioned in opposition to one another.

12. The portable power saw guide system of claim 11, wherein said third guide slot and said fifth guide slot are positioned in opposition to one another.

13. The portable power saw guide system of claim 12, wherein said second guide slot is positioned adjacent to an end of said main body adjacent said third guide slot.

14. The portable power saw guide system of claim 13, wherein said depth C is greater than said depth A.

15. The portable power saw guide system of claim 13, wherein said depth C is greater than said depth B.

16. The portable power saw guide system of claim 13, wherein said height B of said alignment member is less than the difference between depth A and height A.

17. The portable power saw guide system of claim 13, wherein said height B of said alignment member is approximately equal to the difference between depth A and height A.

18. The portable power saw guide system of claim 13, wherein said plurality of guide slots include a first guide slot extending at an angle of approximately 56.1 degrees.
